(19) United States
(12) Patent Application Publication
(10) Pub. No.: US 2021/0276035 A1
(43) Pub. Date: Sep. 9, 2021

(54) Cosmetic Adhesive Applicator

(71) Applicant: FAN GIRL COSMETICS, LLC, Livonia, MI (US)

(72) Inventors: Amanie Mokdad, Canton, MI (US); Maya Darwiche, Dearborn Heights, MI (US)

(21) Appl. No.: 17/188,587

(22) Filed: Mar. 1, 2021

Related U.S. Application Data
(60) Provisional application No. 62/984,459, filed on Mar. 3, 2020.

(51) Int. Cl. B05C 1/02; A41G 5/02

(52) U.S. Cl. CPC B05C 1/027; A41G 5/02

(57) ABSTRACT

An adhesive applicator comprising: a body defining a recess configured to receive an outlet of an adhesive supply; a slot configured to receive a spine member of a false eyelash; and an aperture defined by the body configured to fluidly connect the recess to the slot; wherein the adhesive supply extends from the aperture into the slot so that as a false eyelash including a spine member and at least one eyelash member extending from the spine member is moved along the slot, the adhesive applicator applies adhesive from the adhesive supply to the supply member.

### CROSS-REFERENCE TO RELATED APPLICATION(S)

This application claims priority to and the benefit of U.S. Provisional Application Patent Ser. No. 62/984,459, filed Mar. 3, 2020, the entire disclosure of which is hereby incorporated by reference.

### TECHNICAL FIELD

This disclosure relates generally to devices configured to apply adhesive to false eyelashes.

### BACKGROUND

A false eyelash includes a spine member and eyelash members extending from the spine member. To attach the false eyelash to an eyelid, a user typically applies adhesive to the spine member using an adhesive container. For example, the adhesive container may include a nozzle and adhesive may flow out of the nozzle in response to the user squeezing the adhesive container. The user applies the adhesive to the spine member by moving the nozzle along a length of the spine member. After the adhesive is applied to the spine member, the spine member is placed on an eyelid and the adhesive attaches the spine member to the eyelid.

Adhesive applicators configured to apply adhesive to false eyelashes are herein described. Using a typical adhesive container having an outlet nozzle to apply adhesive to a false eyelash is inefficient and inadequate. For example, application of adhesive onto a spine member of a false eyelash using a typical outlet nozzle is often dependent on the concentration and dexterity of the user. A lapse in concentration or dexterity of the user may result in misapplication of adhesive to undesired locations of the false eyelash, such as onto eyelash members extending from the spine member. Such misapplication of adhesive may result in wasted adhesive and/or in rendering the false eyelash useless. Misapplication of the adhesive may also increase time required for the user to apply adhesive to the false eyelash. Further, application of adhesive using a typical adhesive outlet nozzle often results in a non-uniform distribution of adhesive on the spine member. A non-uniform distribution of adhesive on the spine member often results in inadequate attachment of the spine member to an eyelid due to areas of the spine member having an excessive or inadequate amount of adhesive.

### SUMMARY

Disclosed herein are implementations of an adhesive applicator. In one implementation, an adhesive applicator is configured to apply adhesive from an adhesive supply to a false eyelash including a spine member and at least one eyelash member extending from the spine member. The adhesive applicator comprises a body defining a recess configured to receive an outlet of the adhesive supply. The adhesive applicator comprises a slot configured to receive the spine member of the false eyelash. The adhesive applicator comprises an aperture defined by the body configured to fluidly connect the recess to the slot.

An adhesive applicator comprising: a body defining a recess configured to receive an outlet of an adhesive supply; a slot configured to receive a spine member of a false eyelash; and an aperture defined by the body configured to fluidly connect the recess to the slot; wherein the adhesive supply extends from the aperture into the slot so that as a false eyelash including a spine member and at least one eyelash member extending from the spine member is moved along the slot, the adhesive applicator applies adhesive from the adhesive supply to the supply member.

A method comprising: inserting an adhesive source into a recess within a body portion of an adhesive applicator; inserting a portion of spine member of a false eyelash into a slot within the body portion; generating a bead of adhesive from the adhesive source; moving the spine member so that adhesive is applied to the spine member.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a top, front, and left perspective view of an adhesive applicator.

FIG. 2 is a top and front perspective view of a lid configured to close the adhesive applicator of FIG. 1.

FIG. 3 is a flowchart of a process to apply adhesive to a spine member of a false eyelash using the adhesive applicator of FIG. 1.

FIG. 4A is a top, front, and right perspective view of an adhesive applicator.

FIG. 4B is a front plan view of the adhesive applicator of FIG. 4A.

FIG. 4C is a right plan view of the adhesive applicator of FIG. 4A.

FIG. 5A is a lid configured to close the adhesive applicator of FIGS. 4A-C.

FIG. 5B is a right plan view of the lid of FIG. 5A.

### DETAILED DESCRIPTION

The adhesive applicators described herein include a body that defines a recess configured to receive an outlet of an adhesive source and defines a slot in fluid communication with the recess. The slot is configured to receive a spine member of a false eyelash. Adhesive is supplied to the slot from the adhesive source such that a user may slide the spine member of the false eyelash through the slot to uniformly apply the adhesive along a length of the spine member. In this configuration, users may quickly and consistently apply a uniform distribution of adhesive to spine members of one or more false eyelashes. The first slot wall may be movable about the second slot wall, the third slot wall, or both. The first slot wall may be movable along a track to change a distance between the first slot wall and the aperture. The first slot wall may provide support to the eyelash as adhesive is applied to the eyelash. The first slot wall may provide stability to the eyelash. The first slot wall may provide stability so that adhesive may be applied to the eyelash in a quick manner (e.g., 3 seconds or less, 2 seconds or less, or even 1 second or less).

The adhesive applicator functions to receive any standard glue tube and assist in applying the glue to an eyelash. The adhesive applicator may include one or more slots that receive a portion of an eyelash and assist in providing adhesive to the eyelash. The slot may have a set depth. The depth of the slot may be variable to adjust based upon a size and shape of the eyelash.

The second slot wall functions to support a bottom side of an eyelash and to assist in applying adhesive to the eyelash. The second slot wall may include an apex. The second slot wall may have a flat portion. The second slot wall may taper from an apex towards a first edge, a second edge, or both. The second slot wall may have arcuate portions and flat portions. The arcuate portions may be free of contact with the eyelash. The arcuate portions may prevent adhesive from building on the second slot wall.

The adhesive applicator may be used in a method. The method may include aligning an eyelash within a slot. Moving the eyelash along the slot. Squeezing or applying pressure to the adhesive source. Applying the eyelash to a user. Pushing the eyelash against a first slot wall. Adjusting a location of the eyelash relative to an aperture. Capping the slot. Putting a lid in the slot or over the slot. Cleaning the slot with a lid.

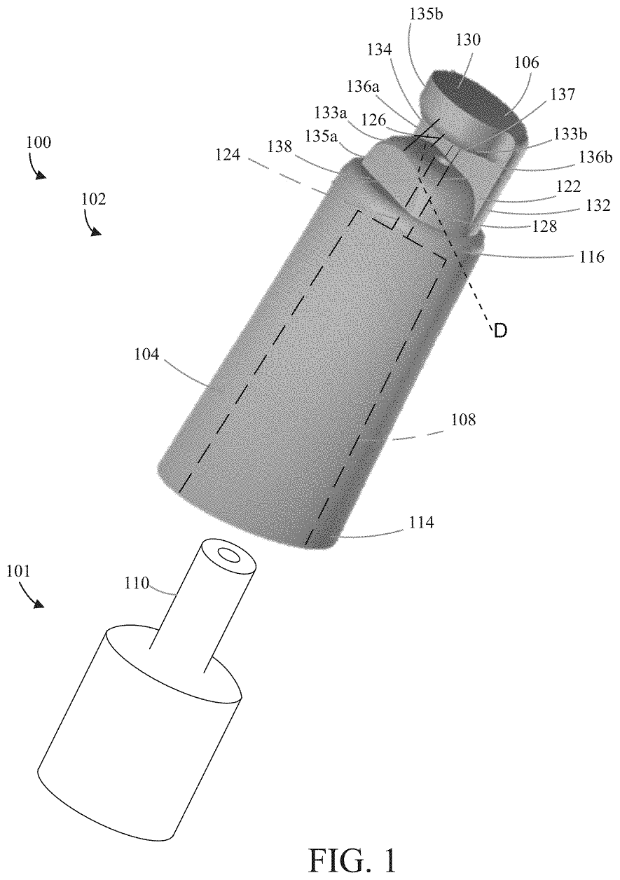

FIG. 1 is a top, front, and left perspective view of an adhesive applicator 100 and an adhesive source 101. The adhesive source 101 can include any container retaining any adhesive. The adhesive applicator 100 includes a body 102. The body 102 includes a first portion 104 and a second portion 106. The body 102 may be made of any plastic, metal, wood, rubber, or any other suitable material. The first portion 104 may be integrally formed with the second portion 106 or the first portion 104 may be attached to the second portion 106. The first portion 104 may have a height of 0.20-1.0 inches (e.g., 0.39 inches). The body 102 may have a height of 0.25-1.5 inches (e.g., 0.54 inches).

The first portion 104 defines a recess 108. The recess 108 is configured to receive an outlet 110 of the adhesive source 101. The outlet 110 may include any nozzle, aperture, or other channel through which adhesive may flow from the adhesive source 101. An interior profile of the first portion 104 is sized and shaped to correspond to an exterior profile of the outlet 110 of the adhesive source 101. For example, the recess 108 may be sized and shaped to receive at least a portion of an outlet nozzle of a cosmetic adhesive container. In other embodiments, the recess 108 may be sized and shaped to receive any portion of any adhesive source. The recess may have a height of 0.10-0.90 inches (e.g., 0.35 inches). The first portion 104 may have a thickness of 0.025-0.1 inches (e.g., 0.050 inches). The first portion 104 may be removably or permanently attached to the outlet 110. If the first portion 104 is removably attached to the outlet 110, a user may attach the body 102 to a first adhesive source, remove the body 102 from the first adhesive source when adhesive from the first adhesive source is depleted, and attach the body 102 to another adhesive source. In this configuration, the body 102 may be reused with multiple adhesive sources.

The first portion 104 may be attached to the outlet 110 via interference fit. The first portion 104 may be made of a rigid material or a flexible material such that the recess 108 may change in shape and/or size to fit adhesive source outlets of varying size and/or shape. In other embodiments, the first portion 104 may include a detent (not shown) extending between the outlet 110 and an interior surface of the first portion 104, where the detent is configured to prevent motion of the first portion 104 relative to the outlet 110. The detent may include a recess defined by the interior surface of the first portion 104 or the outlet 110 configured to receive a protrusion extending from the outlet 110 or the interior surface of the first portion 104. In other embodiments, the first portion 104 may be attached to the outlet 110 using any fastener or any other suitable means.

In the illustrated, non-limiting embodiment, the first portion 104 has a round, conical shape. A diameter of a first end 114 of the first portion 104 is greater than a diameter of a second end 116 of the first portion 104, where the second end 116 is located adjacent to the second portion 106. In other embodiments, the diameter of the second end 116 may be any size relative to the diameter of the first end 114. In other embodiments, the first portion 104 can have a square, rectangular, triangular, cylindrical, tubular, or any other shape.

The second portion 106 of the body 102 extends from the second end 116 of the first portion 104. The second portion 106 defines a slot 122 configured to receive at least a portion of a false eyelash. For example, the slot 122 may be configured to receive a spine member of a false eyelash.

The body 102 defines an aperture 124 configured to fluidly connect the recess 108 and the slot 122. The aperture 124 may have a diameter of 0.010-0.1 inches (e.g., 0.030 inches or 0.040 inches). In this configuration, adhesive may flow from the outlet 110 of the adhesive source 101, through the aperture 124, and into the slot 122 in response to an input generated by the user (e.g., applying force to the adhesive source 101 or actuating a switch of the adhesive source 101). Once adhesive is located in the slot 122, the user may slide the spine member of a false eyelash through the slot 122 to uniformly apply adhesive along a length of the spine member.

The slot 122 extends across a width of the second portion 106 in a direction substantially perpendicular to an axis (not shown) extending through the aperture 124. In other embodiments, the slot 122 may be defined by any portion of the second portion 106. The slot 122 may extend in a direction substantially parallel to the axis extending through the aperture 124 or in any other direction relative to the axis extending through the aperture 124.

The second portion 106 includes a first slot wall 126, a second slot wall 128, and a third slot wall 130. The first slot wall 126, the second slot wall 128, and the third slot wall 130 may form one integral piece or one or more of the first slot wall 126, the second slot wall 128, and the third slot wall 130 may be separately attached to the second portion 106. The first slot wall 126, the second slot wall 128, and the third slot wall 130 define the slot 122. The first slot wall 126 is located a distance (D) from the distal end 135a so that the aperture 124 aligns with a spine member (not shown).

The first slot wall 126 extends from the second end 116 of the first portion 104. The first slot wall 126 includes an exterior side 132 and an interior side 134. The interior side 134 may optionally define a recess 137 configured to retain at least a portion of the adhesive flowing through the aperture 124. Adhesive retained in the recess 137 may be applied to a spine member of a false eyelash as the spine member is moved through the slot 122. The exterior side 132 has a round, semi-circular shape, but in other embodiments may have a flat shape, a square shape, a rectangular shape, or any other shape. The interior side 134 forms a substantially planar surface. In other embodiments, the interior side 134 may form a curved surface or a surface having any other shape.

The second slot wall 128 and the third slot wall 130 each extend from opposing ends of the first slot wall 126. The second slot wall 128 also extends from the second end 116 of the first portion 104 of the body 102. The second slot wall 128 and the third slot wall 130 may each have a height of 0.030-0.10 inches (e.g. 0.060 inches). The aperture 124 extends through the second slot wall 128. The second slot wall 128 and the third slot wall 130 each include a proximate end 133a,b located proximate to the slot 122 and a distal end 135a,b located distal to the slot 122. A distance between the proximate end 133a of the second slot wall 128 and the proximate end 133b of the third slot wall 130 may be 0.020-0.10 inches (e.g., 0.040 inches). The second slot wall 128 and the third slot wall 130 each have a convex shape (e.g., a dome-like shape) such that the proximate ends 133a,b each have a width less than a width of each of the distal ends 135a,b. Rounded edges of the second slot wall 128 and the third slot wall 130 are configured to guide an end of a spine member of a false eyelash into the slot 122. In this configuration, the user may easily insert an end of the spine member into the slot 122. Once an end of the spine member is inserted into the slot 122 between the proximate ends 133a,b, of the second slot wall 128 and the third slot wall 130, the user may slide the spine member through the slot 122 to apply adhesive along a length of the spine member. In other embodiments, the second slot wall 128 and the third slot wall 130 may not have a convex shape and may not have rounded edges. For example, the second slot wall 128 and the third slot wall 130 may each include a square shape or any other shape.

The second portion 106 includes two first lips 136a,b, located on opposite sides of the second slot wall 128 and the third slot wall 130. The first lips 136a,b are defined by the first slot wall 126. For example, the first slot wall 126 has a width greater than a width of the second slot wall 128 and a width of the third slot wall 130 such that the first slot wall 126 forms the first lips 136a,b. The first lips 136a,b, guide an end of a spine member of a false eyelash into the slot 122 and prevent the end of the spine member from slipping out of the slot 122. In other embodiments, the second portion 106 may not include the first lips 136a,b. The body 102 includes a second lip 138 extending between the first portion 104 and the second portion 106. In other embodiments, the body 102 may not include the second lip 138.

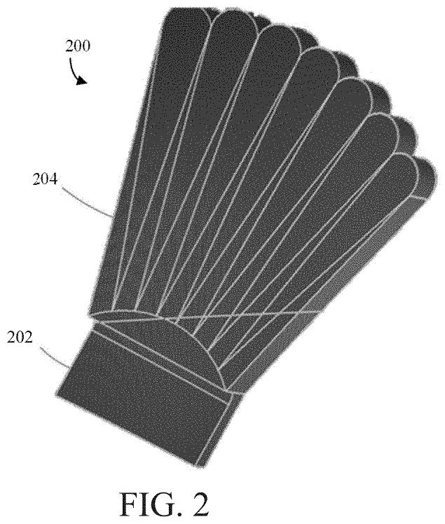

FIG. 2 is a top and front perspective view of a lid 200 configured to close the adhesive applicator 100 of FIG. 1. FIG. The lid 200 may assist in removing any adhesive, adhesive build up, dry adhesive, wet adhesive, or a combination thereof. The lid 200 may be inserted into the slot from a side and may push the adhesive out of the slot as the lid 200 extends therein. The lid 200 or the first lid portion 202 may be sufficiently rigid to remove adhesive, dry adhesive, or both. The lid 200 includes a first lid portion 202 and a second lid portion 204. The first lid portion 202 is configured to prevent adhesive from flowing from the aperture 124 into the slot 122 when the first lid portion 202 is placed in the slot 122. The slot 122 is configured to receive the first lid portion 202. The interior profile of the slot 122 is shaped and sized to correspond to an exterior profile of the first lid portion 202. The first lid portion 202 removably attaches to the second portion 106 of the body 102 via interference fit. When placed in the slot 122, the first lid portion 202 extends from the second slot wall 128 to the third slot wall 130. The first lid portion 202 may also be used by the user to remove adhesive from the slot 122. For example, the user may remove the first lid portion 202 from the slot 122 and use an edge of the first lid portion 202 to scrape fresh or dried adhesive out of the slot 122. In the illustrated, non-limiting example, the first lid portion 202 has a rectangular shape. In other embodiments, the first lid portion 202 may have a square shape, a circular shape, or any other shape.

The second lid portion 204 is configured to be gripped by the user to place the first lid portion 202 inside the slot 122 or to remove the first lid portion 202 from the slot 122. In the illustrated, non-limiting embodiment, the second lid portion 204 has a flat, triangular shape. In other embodiments, the second lid portion may have a circular shape, a square shape, a rectangular shape, or any other shape.

The lid 200 may include a detent (not shown) extending between the first lid portion 202 and an interior surface of the slot 122. The detent is configured to prevent motion of the first lid portion 202 relative to the second portion 106 of the body 102. The detent may include a recess defined by the interior surface of the slot 122 or the first lid portion 202 configured to receive a protrusion extending from the first lid portion 202 or the interior surface of the slot 122. In other embodiments, the first lid portion 202 may be attached to the interior surface of the slot 122 using any fastener or any other suitable means.

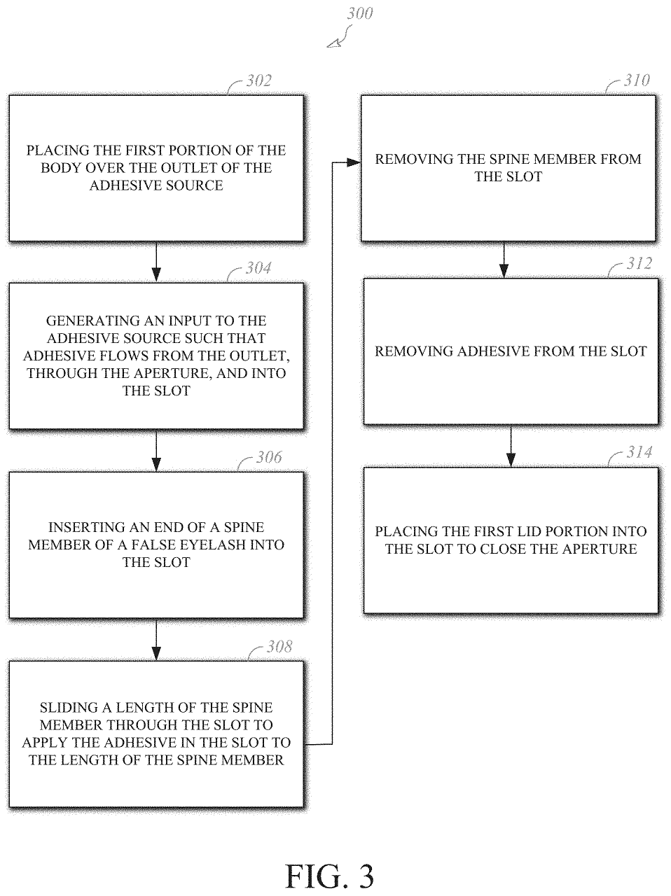

FIG. 3 is a flowchart of a process 300 to apply adhesive to a spine member of a false eyelash using the adhesive applicator 100. In operation 302, the user places the first portion 104 of the body 102 over the outlet 110 of the adhesive source 101 such that the outlet 110 is received inside the recess 108 (e.g., via interference fit). In operation 304, the user generates an input to the adhesive source 101 (e.g., squeezes the adhesive source 101) such that adhesive flows from the outlet 110, through the aperture 124, and into the slot 122. In operation 306, the user inserts an end of a spine member of a false eyelash into the slot 122 between the proximate ends 133a,b of the second slot wall 128 and the third slot wall 130. In operation 308, the user slides a length of the spine member through the slot to apply the adhesive in the slot 122 to the length of the spine member. The adhesive is applied uniformly along the length of the spine member because the interior profile of the slot 122, defined by the interior side 134 of the first slot wall 126 and by the proximate ends 133a,b of the second slot wall 128 and the third slot wall 130, is sized and shaped to correspond to the exterior profile of the spine member. For example, the distance between the second slot wall 128 and the third slot wall 130 may be slightly greater than a thickness of the spine member, such that a gap is defined between the spine member and the second portion 106 of the body 102 while the spine member is located in the slot 122. When the spine member is moved through the slot 122, adhesive located in the slot 122 is moved into the gap such that an optimum amount of the adhesive is applied to the spine member. In operation 310, the user may remove the spine member from the slot 122. After operation 310, the user may apply the spine member to an eyelid.

In operation 312 (e.g., when the user is finished applying adhesive to one or more spine members of one or more false eyelashes) the user may use the first lid portion 202 of the lid 200 to remove adhesive from the slot 122. In operation 314, the user may place the first lid portion 202 into the slot 122 to close the aperture 124 and to prevent adhesive from flowing from the adhesive source 101 into the slot 122. The adhesive source 101 may be stored while the body 102 remains in-place on the outlet 110 of the adhesive source 101 and while the first lid portion 202 remains in-place in the slot 122. The first lid portion 202 may be removed by the user to further apply adhesive to other spine members of other false eyelashes. If the adhesive source 101 is depleted, the outlet 110 of the adhesive source 101 may be removed from the recess 108 of the body 102. The body 102 can then be placed on another adhesive source 101.

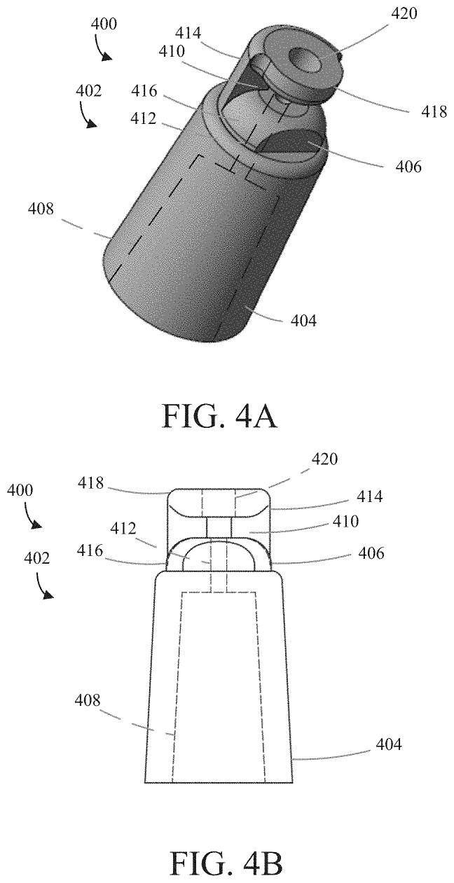

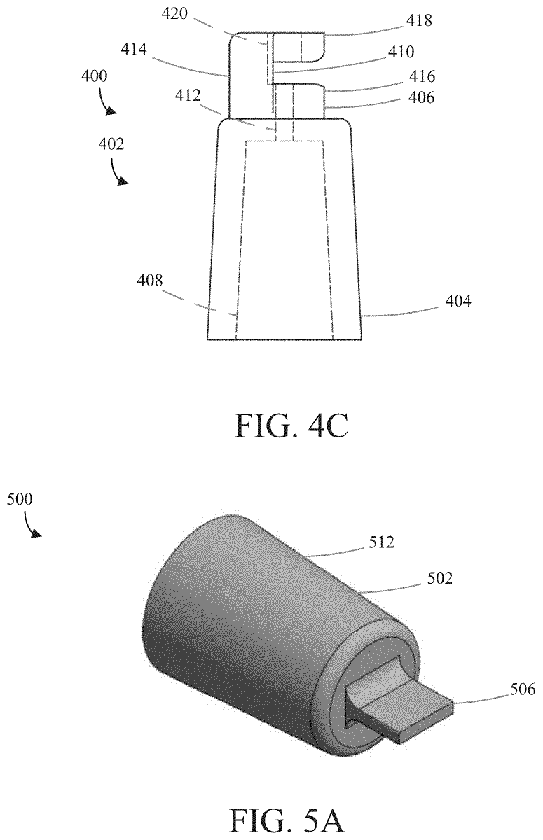

FIG. 4A is a top, front, and right perspective view of an adhesive applicator 400 according to another example. FIG. 4B is a front plan view of the adhesive applicator 400 of FIG. 4A. FIG. 4C is a right plan view of the adhesive applicator 400 of FIG. 4A. The adhesive applicator 400 includes features similar to those of the adhesive applicator 100 except as otherwise described.

The adhesive applicator 400 includes a body 402 having a first portion 404 and a second portion 406. The first portion 404 defines a recess 408. The second portion defines a slot 410 configured to receive at least a portion of a false eyelash. For example, the slot 410 may be configured to receive a spine member of a false eyelash. The body 402 includes an aperture 412 configured to fluidly connect the recess 408 and the slot 410.

The second portion 406 includes a first slot wall 414, a second slot wall 416, and a third slot wall 418. The first slot wall 414, the second slot wall 416, and the third slot wall 418 define the slot 410.

The third slot wall 418 defines a connection aperture 420 through the third slot wall 418. In other embodiments, the connection aperture 420 may not extend through the third slot wall 418 and may extend through a portion of the third slot wall 418. In yet other embodiments, the third slot wall 418 may not define the connection aperture 420. The connection aperture 420 is configured to receive a connection member of a lid described with respect to FIGS. 4A-4B. An axis (not shown) extending through the connection aperture 420 is substantially parallel to an axis (not shown) extending through the aperture 412. In other embodiments, the axis extending through the connection aperture 420 may be located at any angle relative to the axis extending through the aperture 412.

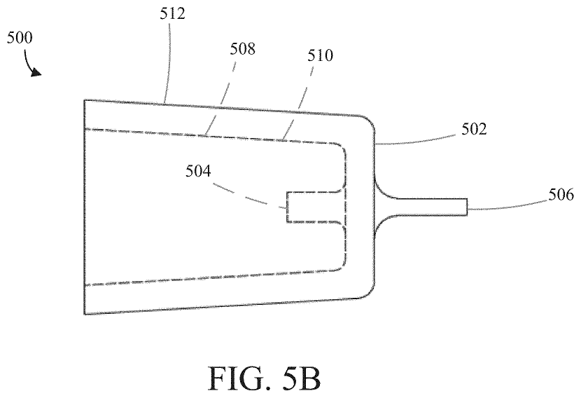

FIG. 5A is a lid 500 configured to close the adhesive applicator 400 of FIGS. 4A-4C. FIG. 5B is a right plan view of the lid 500 of FIG. 5A. The lid 500 is configured to enclose the slot 410 when the lid 500 is attached to the body 402. In this configuration, the body 402 may be stored while the body 402 is attached to an adhesive source such as the adhesive source 101. The lid 500 includes a lid body 502, a connection member 504, and a grip member 506.

The lid body 502 defines a lid recess 508 configured to receive at least a portion of the body 402. For example, when the lid 500 is attached to the body 402, the second portion 406 and part of the first portion 404 of the body 402 may be located inside the lid recess 508. An interior profile of the lid recess 508 is shaped and sized to correspond to an exterior profile of the body 402.

The connection member 504 extends from an interior surface 510 of the lid body 502 inside the lid recess 508. The connection aperture 420 of the body 402 is configured to receive the connection member 504 to removably attach the lid 500 to the body 402. For example, an interior profile of the connection aperture 420 may be shaped and sized to correspond to an exterior profile of the connection member 504 such that the connection member 504 may be attached to the third slot wall 418 via interference fit. Additionally and/or alternatively, the lid 500 may include a detent (not shown) configured to prevent movement between the connection member 504 and the body 402. For example, the detent may include a recess defined by the lid body 502 or the third slot wall 418 configured to receive a protrusion extending from the connection member 504 or the third slot wall 418. In other embodiments, the detent may include a fastener or any other suitable means of attachment. In the illustrated, non-limiting embodiment, the connection member 504 has a round, cylindrical shape, but in other embodiments may have a square shape, a rectangular shape, a dome-like shape, or any other shape.

The grip member 506 extends from an exterior surface 512 of the lid body 502. In the illustrated, non-limiting example, the grip member extends from an end of the lid body 502, but in other embodiments may extend from any portion of the lid body 502. The grip member 506 is configured to be gripped by the user to place the lid 500 on the body 402 to enclose the slot 410 and/or to remove the lid 500 from the body 402. The slot 410 may also be configured to receive the grip member 506 such that the grip member prevents adhesive from flowing from the aperture 412 into the slot 410. For example, an interior profile of the slot 410 may be sized and shaped to correspond to an exterior profile of the grip member 506. The grip member 506 has a flat, rectangular shape but in other embodiments, may have a curved shape, a circular shape, a square shape, or any other shape. The grip member 506 may be used by the user to remove adhesive from inside the slot 410.

Variation 1 may comprise: an adhesive applicator comprising: a body defining a recess configured to receive an outlet of an adhesive supply; a slot configured to receive a spine member of a false eyelash; and an aperture defined by the body configured to fluidly connect the recess to the slot; wherein the adhesive supply extends from the aperture into the slot so that as a false eyelash including a spine member and at least one eyelash member extending from the spine member is moved along the slot, the adhesive applicator applies adhesive from the adhesive supply to the supply member.

Variation 2 may include variation 1 and may further comprise: wherein the body is configured to receive any adhesive supply.

Variation 3 may include any of variations 1 through 2 and may further comprise: wherein the slot has a depth from a distal end of the slot to a first slot wall that is substantially similar to the length of the spine member so that when the spine member is inserted into the slot the spine member contacts the first slot wall of the slot and the spine member is aligned with the aperture so that the adhesive is applied to a predetermined adhesive location on the spine member.

Variation 4 may include any of variations 1 through 3 and may further comprise: wherein the first slot wall and slot are located between a second slot wall and a third slot wall.

Variation 5 may include any of variations 1 through 4 and may further comprise: wherein the slot is formed by a first slot wall, a second slot wall, and a third slot wall where the second slot wall and the third slot wall are spaced apart by the first slot wall so that the slot extends between the second slot wall and the third slot wall.

Variation 6 may include any of variations 1 through 5 and may further comprise: wherein the second slot wall has a first edge, a second edge, and a top portion with the top portion being an apex and the second slot wall curving away from the apex towards the first edge and the second edge respectively.

Variation 7 may include any of variations 1 through 6 and may further comprise: wherein the apex is a flat planar surface that has a first side and a second side that are an arcuate curvature from the flat planar surface to the first edge and the second edge respectively.

Variation 8 may include any of variations 1 through 7 and may further comprise: wherein the outlet is located within the flat planar surface.

Variation 9 may include any of variations 1 through 8 and may further comprise: wherein the third slot wall extends cantilever from the first slot wall.

Variation 10 may include any of variations 1 through 9 and may further comprise: wherein the second slot wall includes a distal end forming a flat surface and the body portion includes a lip that extends outward beyond the distal end.

Variation 11 may include any of variations 1 through 10 and may further comprise: a lid.

Variation 12 may include any of variations 1 through 11 and may further comprise: the lid includes a first lid portion that fits within the slot.

Variation 13 may include any of variations 1 through 12 and may further comprise: wherein the lid includes a second lid portion that extends outward from the first lid portion so that a user can grip the second lid portion to remove the first lid portion from the slot.

Variation 14 may include any of variations 1 through 13 and may further comprise: wherein the first lid portion closes the aperture and cleans any excess glue from a first slot wall, a second slot wall, a third slot wall, or a combination thereof.

Variation 15 may include any of variations 1 through 14 and may further comprise: wherein the body includes a first portion and a second portion with the first portion including the recess and the second portion including the slot.

Variation 16 comprising: a method comprising: inserting an adhesive source into a recess within a body portion of an adhesive applicator; inserting a portion of spine member of a false eyelash into a slot within the body portion; generating a bead of adhesive from the adhesive source; moving the spine member so that adhesive is applied to the spine member.

Variation 17 may include the method of variation 16 or the adhesive applicator of any of variations 1 through 15 and may further comprise: aligning the spine member within the slot by moving the spine member into contact with a first slot wall of the slot.

Variation 18 may include the method of variation 16 or 17 or the adhesive applicator of any of variations 1 through 15 and may further comprise: removing the spine member from the slot.

Variation 19 may include the method of variation 16 through 18 or the adhesive applicator of any of variations 1 through 15 and may further comprise: placing a lid into the slot to close the aperture.

Variation 20 may include the method of variation 16 through 19 or the adhesive applicator of any of variations 1 through 15 and may further comprise: cleaning the slot with a first lid portion of a lid so that any excess adhesive is removed from the slot.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.
100 Adhesive Applicator
101 Adhesive Source
102 Body
104 First Portion
106 Second Portion
108 Recess
110 Outlet
114 First end
116 Second end
122 Slot
124 Aperture
126 First slot wall
128 Second slot wall
130 Third slot wall
132 Exterior side
133 (a)(b) Proximate end
134 Interior side
135 (a)(b) Distal end
136(a)(b) First lips
137 Recess
138 Second lip
200 Lid
202 First lid portion
204 Second lid portion
300 Process
302 Operation
304 Operation
306 Operation
308 Operation
310 Operation
312 Operation
400 Adhesive applicator
402 Body
404 First portion
406 Second portion
408 Recess
410 Slot
412 Aperture
414 First slot wall
416 Second slot wall
418 Third slot wall
420 Connection Aperture
500 Lid
502 Lid body
504 Connection member
506 Grip Member
508 Lid Recess
510 Interior surface
512 Exterior surface

What is claimed is:

1. An adhesive applicator comprising:
a body defining a recess configured to receive an outlet of an adhesive supply;
a slot configured to receive a spine member of a false eyelash; and
an aperture defined by the body configured to fluidly connect the recess to the slot;
wherein the adhesive supply extends from the aperture into the slot so that as a false eyelash including a spine member and at least one eyelash member extending from the spine member is moved along the slot, the adhesive applicator applies adhesive from the adhesive supply to the supply member.

2. The adhesive applicator of claim 1, wherein the body is configured to receive any adhesive supply.

3. The adhesive applicator of claim 1, wherein the slot has a depth from a distal end of the slot to a first slot wall that is substantially similar to the length of the spine member so that when the spine member is inserted into the slot the spine member contacts the first slot wall of the slot and the spine member is aligned with the aperture so that the adhesive is applied to a predetermined adhesive location on the spine member.

4. The adhesive applicator of claim 3, wherein the first slot wall and slot are located between a second slot wall and a third slot wall.

5. The adhesive applicator of claim 1, wherein the slot is formed by a first slot wall, a second slot wall, and a third slot wall where the second slot wall and the third slot wall are spaced apart by the first slot wall so that the slot extends between the second slot wall and the third slot wall.

6. The adhesive applicator of claim 5, wherein the second slot wall has a first edge, a second edge, and a top portion with the top portion being an apex and the second slot wall curving away from the apex towards the first edge and the second edge respectively.

7. The adhesive applicator of claim 6, wherein the apex is a flat planar surface that has a first side and a second side that are an arcuate curvature from the flat planar surface to the first edge and the second edge respectively.

8. The adhesive applicator of claim 7, wherein the outlet is located within the flat planar surface.

9. The adhesive applicator of claim 5, wherein the third slot wall extends cantilever from the first slot wall.

10. The adhesive applicator of claim 5, wherein the second slot wall includes a distal end forming a flat surface and the body portion includes a lip that extends outward beyond the distal end.

11. The adhesive applicator of claim 1, further comprising a lid.

12. The adhesive applicator of claim 11, wherein the lid includes a first lid portion that fits within the slot.

13. The adhesive applicator of claim 12, wherein the lid includes a second lid portion that extends outward from the first lid portion so that a user can grip the second lid portion to remove the first lid portion from the slot.

14. The adhesive applicator of claim 12, wherein the first lid portion closes the aperture and cleans any excess glue from a first slot wall, a second slot wall, a third slot wall, or a combination thereof.

15. The adhesive applicator of claim 1, wherein the body includes a first portion and a second portion with the first portion including the recess and the second portion including the slot.

16. A method comprising:
inserting an adhesive source into a recess within a body portion of an adhesive applicator;
inserting a portion of spine member of a false eyelash into a slot within the body portion;
generating a bead of adhesive from the adhesive source;
moving the spine member so that adhesive is applied to the spine member.

17. The method of claim 16, further comprising aligning the spine member within the slot by moving the spine member into contact with a first slot wall of the slot.

18. The method of claim 16, further comprising removing the spine member from the slot.

19. The method of claim 16, further comprising placing a lid into the slot to close the aperture.

20. The method of claim 16, further comprising cleaning the slot with a first lid portion of a lid so that any excess adhesive is removed from the slot.
